(19) United States
(12) Patent Application Publication
(10) Pub. No.: US 2005/0046607 A1
(43) Pub. Date: Mar. 3, 2005

(54) Ultra high resolution radar with active electronically scanned antenna (AESA)

(76) Inventor: Alla Volman, Newtown, PA (US)

Correspondence Address: Alla Volman, 11 Caldwell Circle, Newtown, PA, 18940, US

(21) Appl. No.: 10/655,554

(22) Filed: Sep. 2, 2003

(51) Int. Cl. G01S 7/28

(52) U.S. Cl. 342/109; 342/111; 342/113; 342/116; 342/139; 342/146; 342/157; 342/158; 342/192; 342/196; 342/372

(57) ABSTRACT

An ultra-high resolution radar system and technique for transmit or receive AESAs or that yields performance substantially greater than, that of conventional radar systems and techniques while being simple and inexpensive to manufacture. The device comprises the transmit/receive flat or conformal AESA or AESAs steering beam or beams non-depressively, and creating RF FM modulated pulse signals of identical shape and duration through a resistive multiport voltage divider/dividers electrically connected VCOs, RF mixers and STALO or any other narrow-band or wide-band source of RF signals, and to a plurality of radiating elements in order to generate signals providing simultaneously the required beam or beams azimuth and elevation steering electronically and receiving target-echo return pulse signals.

### BACKGROUND OF THE INVENTION

1. Field of the Invention

This present invention relates generally to ground base, airborne, spaceborne, missiles, ship based scanning radars, or other sensing systems for experimental, military, or commercial applications, and more particularly the present invention relates to a multifunctional scanning radar with AESA or AESAs providing extremely flexible electronic beam/beams steering without conventional variable phase shifters or time delay devices and improved angle and range resolution, clatter and jamming performance.

2. Description of the Prior Art

Modern radar, communication, and sensing systems are finding increasing use for a array antenna assembled from a great many similar radiating elements, each element being individually controlled in phase and amplitude. A salient advantage of an array antenna is the ability to scan the beam or many beams very fast electronically without moving the mass of the array antenna. The accurate measurement and tracking of the target's relative position in the range, azimuth angle, elevation angle, and velocity requires very flexible and special search patterns, such as helical, circular, unidirectional, bidirectional, T.V. raster, palmer, conical, cluster, track-while-scan, etc. The concrete type and method of scanning used depends on the purpose and type of radar and on the antenna size and design. In some cases, the type of scan will change with the particular system mode of operation. The array antenna scan strategy can be very complicated and difficult to realize because of the inadequate phase shifter accuracy or scan speed, extra mass, large size of the elements providing the beams steering, and rather high cost of used technologies.

About 50 years ago it was proposed [1-19, 22, 24] and extensively studied a new type of electronically scanning radar performing the within-pulse beam steering. As in the case of conventional monostatic radar the transmit/receive array antenna of this radar consists of a stack of radiating elements uniformly or nonuniformly spaced and composed into rows and columns. Each element of array is usually coupled to a high power amplifier (HPA) by way of a circulator, and a low noise amplifier (LNA) coupled to each element of array by way of the same circulator. Bistatic radars use separate transmit and receive antenna arrays. The only extra element that is required for the beam steering is a low power RF signal source that can ramp its output frequency over some range as a function of time. There are no traditional phase shifters or true time delay devices.

This well-known phenomenon of electronic scanning has been described in several patents and publications [1-19, 22, 24] as effect of ultra fast scanning, within pulse scanning, element-signal multiplexing technique, frequency-modulation scanning, continuously steering, time-modulation scanning, virtual time delay beam steering, and modulation scan array radar (MOSAR) techniques, frequency offset, etc. There are some obvious advantages of all these approaches: the possibility of ultra rapid coverage of the wide angular sector during the single pulse duration, the simple radar schematic implementation without traditional bank of phase shifters or true time delay devices. The main disadvantage is the impossibility to realize the traditional radar scan strategies mentioned above because of the array antenna scans continuously through the angular coverage of interest back and forth during the pulse without stopping, widely spreading the transmitting energy. The consequence is the worsen signal/noise ratio [14], and the radar performance degradation. More sophisticated ultra wide-bend radar system “ . . . that includes . . . signal processor for electronically scanned arrays utilizes frequency offset generation (FOG) to achieve beam steering as compared with phase shift and time delay techniques of conventional radars” is described in the U.S. Pat. No. 5,351,053 [22] issued to Wicks et el., the disclosure of which is incorporated herein by reference. In the cited invention “ . . . frequency offset generation between adjacent X and Y elements . . . ” is used “ . . . to electronically steer the transmitted beam in azimuth and elevation.” The similar technique is proposed for receiver array antenna because “ . . . the frequency offset between X and Y elements can indicate the azimuth and elevation from which the radar signals have come.” In order to improve radar performance there is an ultra wide-band chirp generator. The main beam angular position is not stationary and depends on time and frequency offset, so as before the transmitting energy is widely scattered in space and the worsen signal/noise ratio is expected.

There is a need for multifunctional scanning radar with fast and ultra fast flexible beam steering. There is a need for narrow-band or wide-band multifunctional scanning radar with high angular or range resolution, jamming or clatter rejection, etc. There is a need for wide and ultra wide-band multifunctional scanning radar with frequency independent beam steering. There is a need for multifunctional scanning radar with high angular or range resolution that is low cost.

### SUMMARY OF THE INVENTION

According to embodiments of the present invention, an ultra high resolution radar with AESA steering beam or beams non-dispersively without phase shifters or true time delay elements, a method to determine coordinates in space of one target or more targets, a velocity of said target or targets relative to said radar and a cross-range of said target is provided. The radar of the present invention can operate at any frequency band, can be narrow-band, wide-band, or ultra wide-band, and provides the angular accuracy greater than conventional radars in tracing mode, the range resolution better than the wavelength, and the cross-range resolution about the wavelength.

According to embodiments of the present invention, said radar includes a transmit/receive flat (or conformal) array antenna with displaced phase center comprising plurality of radiating elements uniform or nonuniform spaced, said radiating elements uniform or nonuniform excited to transmit and collect propagating electromagnetic energy.

According to embodiments of the present invention, said radar includes two or more flat (or conformal) array antennas with said uniform or nonuniform radiating element spacing, uniform or nonuniform said element excitation, the one or several said antenna arrays to transmit and the other said antenna arrays to collect propagating electromagnetic energy with a number of said elements.

According to embodiments of the present invention, said radar includes the tracking system electrically connected to said transmit flat (or conformal) AESA and comprising:
a waveform signal generator which generates a train of a designated form of voltage pulse signals with a designated repetition time, said voltage pulse signal duration is at least longer than the required duration of the AESA radiated or collected signal;
a resistive multiport voltage divider electrically connected to said waveform generator, said resistive multiport voltage divider providing plurality of said voltage pulse signals of identical shape and duration but different consecutive magnitude;
a plurality of voltage control oscillators (VCO), each of said VCO input electrically connected to different output of said resistive multiport voltage divider, and generating plurality of different frequency modulated (FM) pulse signals;
a plurality of 2:1 power dividers, each of said VCO output electrically connected to input of said 2:1 power divider, one output of said 2:1 power divider electrically connected to 90° phase shifter;
a stable local RF oscillator (STALO) or any other narrow-band or wide-band source of RF signals electrically connected to a multiport power divider, each output port of said multiport power divider connected to said 2:1 power divider, and one of the output ports of said 2:1 power diver electrically connected to a 90° phase shifter;
a plurality of mixers, one input port of each couple of said mixers electrically connected to said 2:1 power dividers with 90° phase shifter behind said STALO or any other narrow-band or wide-band source of RF signals and another input port of each couple of said mixers electrically connected to said 2:1 power divides with 90° phase shifter behind said VCOs;
a plurality of hybrid-ring directional couplers and each of said hybrid-ring directional coupler electrically connected to each couple of said mixer output ports providing a sum signal at one port of said hybrid-ring directional coupler and a difference signal at another port of said hybrid-ring directional coupler;
a plurality of HPAs and each input port of said HPAs electrically connected to each said output port of said hybrid-ring directional coupler;
a plurality of radiating elements forming AESA, electrically connected through circulators or hybrid to output ports of said HPAs, transmitting signals into space, and steering beam. A means using a different said FM signals coming to said radiating elements for said steering beam enables to provide the angular accuracy greater than delta.theta.=.wavelength./(100*.antenna.diameter.) in tracing mode, the range resolution better than the wavelength, and the cross-range resolution about the wavelength.

According to embodiments of the present invention, said radar includes the tracking system electrically connected to said receiving flat (or conformal) AESA with displaced phase center and comprising:
a plurality of radiating elements forming said AESA beam, electrically connected through circulators or hybrids to input ports of LNAs, amplifying signals received from space;
a plurality of mixers, one input port of each said mixer electrically connected to each of said LNA and another input port electrically connected to each said output port of said hybrid-ring directional coupler;
a power combiner, each input port of said combiner electrically connected to output port of each of said mixers;
a processing block electrically connected to output of said power combiner, providing a mixing and narrow band filtering of a transmitted signal replica and said replica spectrum with a received signal and said received signal spectrum. The differences between said replica and said received signal coming as a reflected signal from a target enable to provide the angular accuracy greater than delta.theta.=.wavelength./(100*.antenna.diameter.) in tracing mode, the range resolution better than the wavelength, and the cross-range resolution about the wavelength.

According to embodiments of the present invention, said radar includes the tracking system electrically connected to said transmit flat (or conformal) multibeam AESA with displaced phase center and comprising:
several said waveform signal generators which generate a different trains of a designated form of voltage pulse signals with a different designated repetition time, said voltage pulse signal duration is at least longer than the required duration of said multibeam AESA radiated signals;
said resistive multiport voltage divider electrically connected to said waveform generators, said resistive multiport voltage divider providing plurality of said voltage pulse signals of identical shape and duration but different magnitude;
said plurality of voltage controlled oscillators (VCO), each of said VCO input electrically connected to different output of said resistive multiport voltage divider, and generating plurality of different frequency modulated (FM) pulse signals;
said plurality of 2:1 power dividers, each of said VCO output electrically connected to input of said 2:1 power divider, one output of said 2:1 power divider electrically connected to 90° phase shifter;
said stable local RF oscillator (STALO) or any other narrow-band or wide-band source of RF signals electrically connected to a multiport power divider, each output port of said multiport power divider connected to said 2:1 power divider, and one of the output ports of said 2:1 power diver electrically connected to a 90° phase shifter;
said plurality of mixers, one input port of each couple of said mixers electrically connected to said 2:1 power dividers with 90° phase shifter behind said STALO or any other narrow-band or wide-band source of RF signals and another input port of each couple of said mixers electrically connected to said 2:1 power divides with 900 phase shifter behind said VCOs;
said plurality of hybrid-ring directional couplers and each of said hybrid-ring directional coupler electrically connected to each couple of said mixer output ports providing a sum signal at one port of said hybrid-ring directional coupler and a difference signal at another port of said hybrid-ring directional coupler;
said plurality of HPAs and each input port of said HPAs electrically connected to each said output port of said hybrid-ring directional coupler;
said plurality of radiating elements forming said multibeam AESA, electrically connected through circulators to output ports of said HPAs, transmitting signals into space, and steering beam or beams. A means using a different said FM signals coming to said radiating elements for said steering beam or beams enables to provide the angular accuracy greater than .delta.theta.=.wavelength./(100*.antenna.diameter.) in tracing mode, the range resolution better than the wavelength, and the cross-range resolution about the wavelength.

According to embodiments of the present invention, said radar includes the tracking system electrically connected to said receiving flat (or conformal) said multibeam AESA with displaced phase center and comprising:
said plurality of radiating elements forming said AESA beams, electrically connected through circulators to input ports of LNAs, amplifying signals received from space;
said plurality of mixers, one input port of each said mixer electrically connected to each of said LNA and another input port electrically connected to each said output port of said hybrid-ring directional coupler;
said power combiner, each input port of said combiner electrically connected to output port of each of said mixers;
multichanel matched filter electrically connected to output of said power combiner, providing the separation of said received signals of said different beams;
several said processing blocks electrically connected to outputs of said multichanel matched filter, providing a mixing and narrow band filtering of each transmitted signal replica and said replica spectrum with each received signal and said received signal spectrum. The differences between said replica and said received signal coming as a reflected signal from each target enable to provide the angular accuracy greater than .delta.theta.=.wavelength./(100*.antenna.diameter.) in tracing mode, the range resolution better than the wavelength, and the cross-range resolution about the wavelength.

### BRIEF DESCRIPTION OF THE DRAWINGS

FIG. 1 is an exemplary diagram showing the AESA beam angular position at the different moments of time according to an embodiment of the present invention;

FIG. 2a depicts an exemplary voltage pulse waveform required for the elevation scan according to an embodiment of the present invention;

FIG. 2b depicts an exemplary voltage pulse waveform required for the azimuth scan according to an embodiment of the present invention;

FIG. 3 illustrates the equations letting perform the required voltage pulse waveform for elevation and azimuth scan according to an embodiment of the present invention;

FIG. 4 illustrates an exemplary plot for the output voltage signals V1, V2, V3, and V4 in decibels as a function of the normalized to wavelength range displacement according to an embodiment of the present invention;

FIG. 5 illustrates an exemplary plot for the output voltage signals V1, V2, V3, and V4 in decibels as a function of relative angular displacement according to an embodiment of the present invention;

FIG. 6 is a block-diagram showing the exemplary configuration of radar tracking system-processing signals according to an embodiment of the present invention;

FIG. 7 is an exemplary block-diagram of a system providing a plurality of the column or row RF FM signals to electronically steer an transmit and receive AESA main beam according to an embodiment of the present invention;

FIG. 8 is an exemplary block-diagram of a system providing a plurality of signals with time dependable FM to support the system shown in FIG. 7 and according to an embodiment of the present invention;

FIG. 9a illustrates one of the conventional chip circuit realizations of ring VCO with wide tuning range from 40 Hz to 380 MHz and rise/fall time 4.3 ns incorporated herein by reference [23];

FIG. 9b illustrates the frequency-voltage characteristic of chip VCO shown in FIG. 9a incorporated herein by reference [23];

FIG. 10 is exemplary block-diagram of the sub-block providing a plenty of time dependable FM video signals according to an embodiment of the present invention;

FIG. 11 is an exemplary simplified mixer circuit with 180 degrees inverter and switch to reverse the direction of scan to negative angles according to an embodiment of the present invention;

FIG. 12 is an exemplary excitation of one AESA row providing the shifted phase center according to an embodiment of the present invention.

### DETAILED DESCRIPTION OF THE INVENTION

The present invention is now described more fully hereinafter with reference to the accompanying drawings that show a preferred embodiment of the present invention. The present invention, however, may be embodied in many different forms and should not be construed as limited to embodiments set forth herein. Appropriately, embodiments are provided so that this disclosure will be thorough, complete and fully convey the scope of the present invention.

According to embodiments of the present invention, each transmitting element of said AESA radiates pulse signals with different waveform, so the phase and power spectrum of signal radiated by AESA and illuminated target/targets becomes the function of the range, elevation and azimuth angle. With proper processing the receiver can decode this vital data. This novel and important feature of the invention presented, allows get a stationary beam position, any conceivable scan pattern, high signal-to-noise ratio in tracking mode, and as the consequence of it the ultra-high angular and range resolution for the radars with quite moderate bandwidth.

According to embodiments of this invention, a radar AESA consists of a plurality of radiation elements spatially arranged into rows and columns and forming a directivity pattern which is combined in the space by varying an amplitude and a phase of each radio signal received by and transmitted from all the radiating elements so that electromagnetic energy is increased towards a designated direction or directions. Each row of elements is horizontal and parallel to the ground, and each column of elements is vertical and perpendicular to the ground.

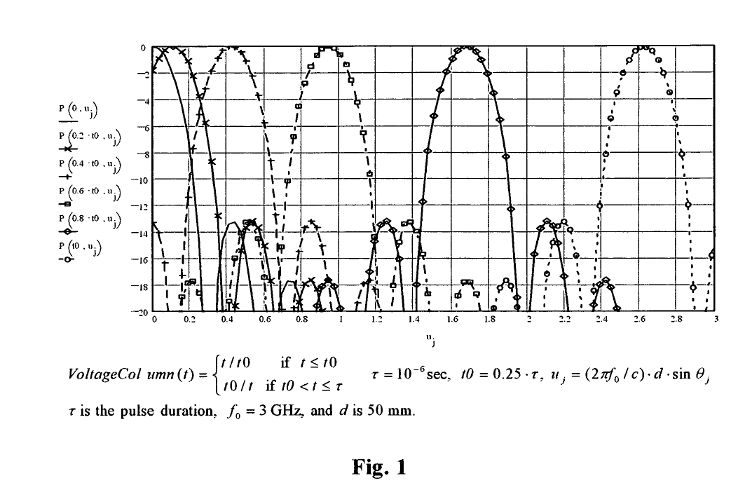

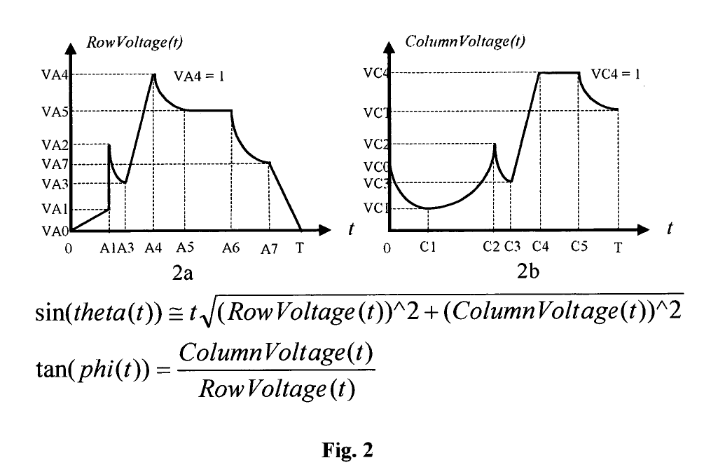

For the sake of the simplicity and to illustrate the theory of operation only, let us consider an transmit linear AESA of one row scanning in azimuth direction, and there is no tapering. According to embodiments of this invention, the first radiating element of this linear array is excited by a RF pulse signal of some duration, the .RF1. frequency is constant and equals to a carrier frequency .RF0. The second radiator to the right is excited by a .RF2. FM pulse signal of the same duration, but the .RF2. frequency equals to a carrier frequency plus a dependant on time .t. variation .DELTAF.(.t.), that is proportional to a normalized waveform generator column voltage .VoltageColumn.(.t.) shown in FIG. 2b:
.RF2.=.RF0.+.DELTAF.(.t.)=.RF0.+.coef.*.VoltageColumn.(.t.)
where .coef. is the constant depending on a modulation characteristic of VCO connected to a voltage source. The next radiator to the right is excited by a .RF3. FM pulse signal of the same duration, but now the RF frequency equals to a carrier frequency plus a double frequency variation 2*.DELTAF.(.t.), that is proportional to a waveform generator column voltage 2*.VoltageColumn.(.t.):
.RF3.=.RF0.+2*.DELTAF.(.t.)=.RF0.+2*.coef.*.VoltageColumn.(.t.)
Continuing this procedure we can get for the last M-th radiating element
.RFM.=.RF0.+M*.DELTAF.(.t.)=.RF0.+M*.coef.*.VoltageColumn.(.t.)
The considering linear array has a peak gain in the elevation direction .theta0.(.t.):
Sin(.theta0. (.t.))=.coef.*.omega0.*.t.*.VoltageColumn.(.t.)/(d/c)
where d is the separation between radiating elements, c is the light velocity, and .omega0.=2* .pi.*.RF0. The amplitude .amp.(.t.,.theta.) of a signal radiated at any angular direction .theta. is given by:
.amp.(.t.,.theta.)=|Sin(M*×(.t.,. theta.))/sin(×(.t.,.theta.))|
where×(.t.,.theta.)=(d*.pi./.lambda.)*(.coef.*.t.*.DELTAF.(.t.)−Sin(.theta.)). The phase .phase.(.t.,.theta.) of the signal radiated at any angular direction .theta. is given by:
.phase.(.t.,.theta.)=M*×(.t.,.theta.)
Let us consider the azimuth beam movement if the normalized waveform generator output voltage has view shown in FIG. 2b. Suppose the voltage variation between .t.=0 and .t.=.C1. is given by:
.VoltageColumn.(.t.)=1/(.VC0. +.omega0.*.t.)
where the voltage .VC0. is shown in FIG. 1b and .omega0.=2*.pi.*.RF0. Since
Sin(.theta0. (.t.))=.coef.*.omega0.*.t.*/((d/c)*(.VC0. +.omega0.*.t.)≈.coef./(.VC0.*d/c)
the beam peak shifted very fast from the angular position theta.=0 at .t.=0 to the angular position described this equation and keeps stationary position until .t.=C1. Starting from the moment of time .t.=C1. the beam peak shifts to the angular position .theta.(.C2.) Sin(.theta0.(.C2.))=(.coef.*.omega0.*.C2.*/(d/c))*(.VC1.+(.VC2.−.VC1.)*(.t.−.C1.)\hat{ }2/(.C2.−.C1.)\hat{ }2) and so on. FIG. 1 illustrates the beam shape and it's movement until the beam reaches the stationary angular position at .t.=t0.

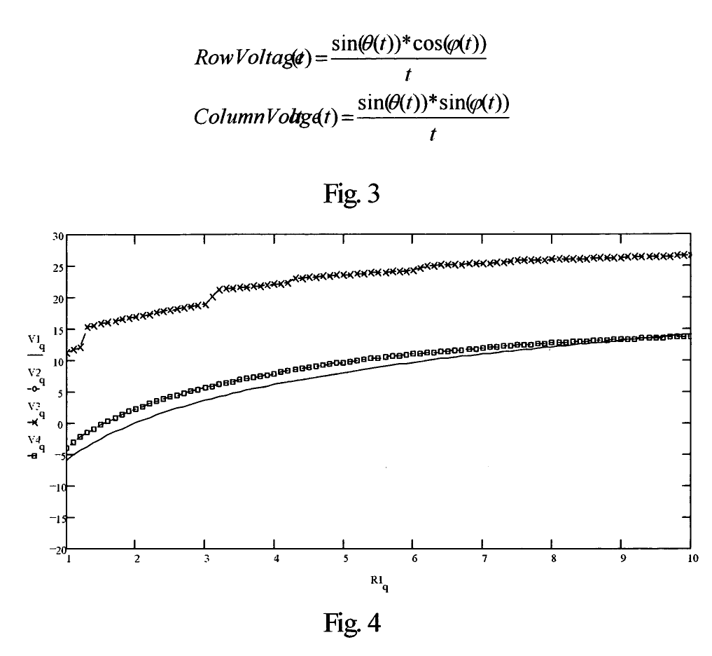

The possible column and row voltage variations and the equations describing 2D steering are shown in FIG. 2. If the beam steering procedure is given the column and row voltage variations can be obtained from the equation shown in FIG. 3. As the RF pulse duration is about .tau.−t0 the radar proposed in the present invention does not require an ultra-wide band signal to get remarkable range and angular resolution.

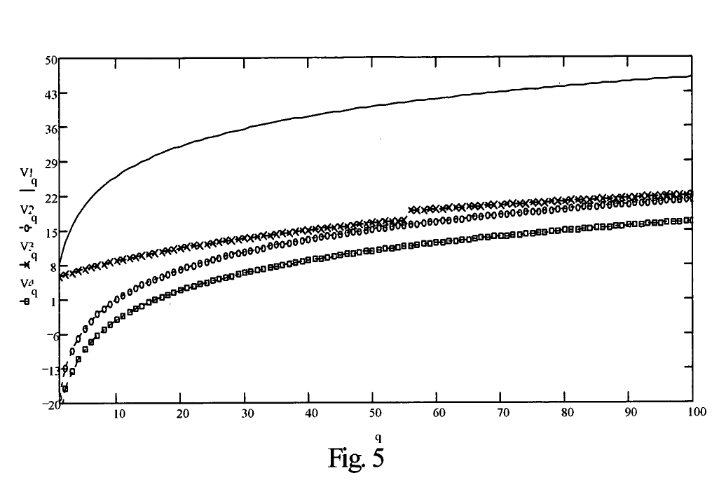

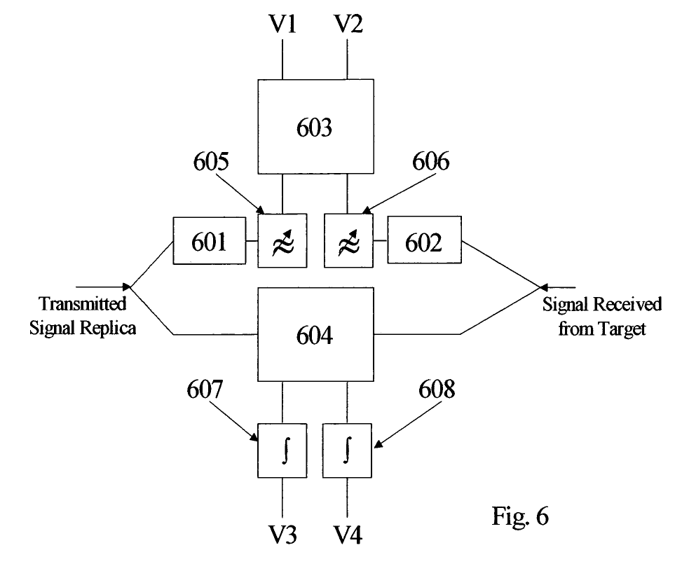

According to embodiments of this invention and the equations written above, the radiated pulse signal waveform and its power and phase spectrum is the function of elevation and azimuth angles. That is the key for high and ultra high resolution. The block diagram one of the possible radar tracking system recovering the radar tracking data is shown in FIG. 6. Many other designs including a full digital processing tracking block may be utilized. One half of the detecting pulse signal carrying information about the range and angular position of target/targets goes through the block 602 providing the Fast Fourier Transform (FFT), narrow-band filter 606, and comes to the comparison block 603. One half of the transmitted pulse signal replica goes through the identical block 601 providing the Fast Fourier Transform (FFT), identical narrow-band filter 605, and comes to the same comparison block 603. The output voltage signals V1 and V2 are the difference in power and phase spectrum of these two signals. The narrow-band filters 605 and 606 limit the noise captured prior to the comparison block 603 and enhance the radar sensitivity and resolution. Each of second half of the detecting and replica signal goes straight to the second comparison block 604 and separate but identical integrators 607 and 608 with gating circuits providing the limit of the noise captured prior to the integrators and improving system signal-to-noise ratio. The output voltage signals V3 and V4 carry the difference in the envelope and phase of these two signals during the pulse rise time. FIG. 5 shows all this voltages variations as a function of angular displacement. Each unit q corresponds to 10\hat{ }(−4), thus two targets both at a range of 2,000 kilometers would have be separated by roughly 440 meters or less in a cross-range direction to the beam (that is, in azimuth or elevation) for the radar to be able to distinguish them as separate objects. That is about one order better than the conventional radars can do [21]. So high angular sensitivity lets easily discriminate the signals coming through the main antenna beam and sidelobes, recognize jamming and clutter signals. FIG. 4 shows all this voltages variations as a function of range of a target measured in the radar carrier wavelength. According to this data the radar of the present invention could distinguish between two objects separated by half of wavelength or less, or could observe variations in the radar cross section of a target along the radial direction with the same resolution. Note for comparison that a conventional X-band radar [21] with a bandwidth of 1 GHz gives a range resolution of 5 wavelengths only. So the radar of the present invention with much more narrow bandwidth and accordingly lower cost has about one order better range and angular resolution than the conventional radars.

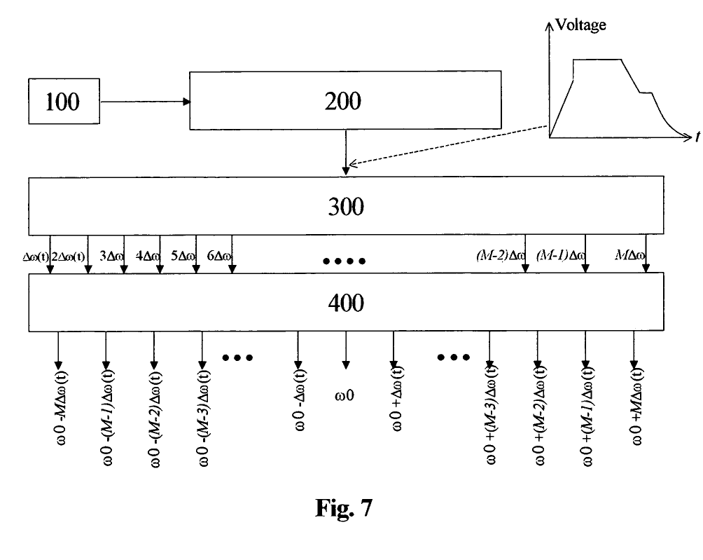

In developing the radar operation of the invention presented, consider the block diagram of a subsystem providing a plurality of the column or row RF FM signals to electronically steer an transmit and receive AESA main beam. The manager block 100 using the information of the required by the radar scan strategy and the equations shown in FIG. 3 creates the input data for the column and row waveform generators. For simplicity in this figure only one column generator 200 for an azimuth scan is shown. The block 300 is electrically connected to the block 200 consists of a plurality of VCOs and output ports with different FM signals with progressive incremental offset as it is shown in FIG. 7. The next block 400 is electrically connected to the block 300 consists of a plurality of mixers and STALO or any other narrow-band or wide-band source of RF signals to produce a plurality of RF FM signals to feed a plurality of transmit AESA or AESAs radiation elements and a plurality of reference signals for receive AESA or AESAs. Note that the similar set of RF FM signals distributed between AESA or AESAs rows can be used for elevation scan. In order to get the shifted phase center of AESA or AESAs the signal with the lowest frequency is considered as a carrier signal and must be delivered to the first left or last radiating element of the first row.

A novel and important feature of the invention presented is that all the RF FM signals vary as a function of time during the pulse duration to achieve beamsteering, beamsteering stops, and high radar resolution.

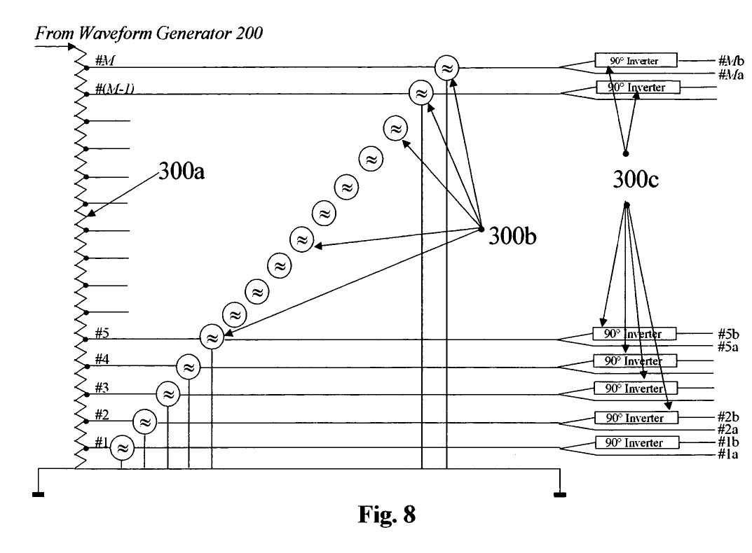

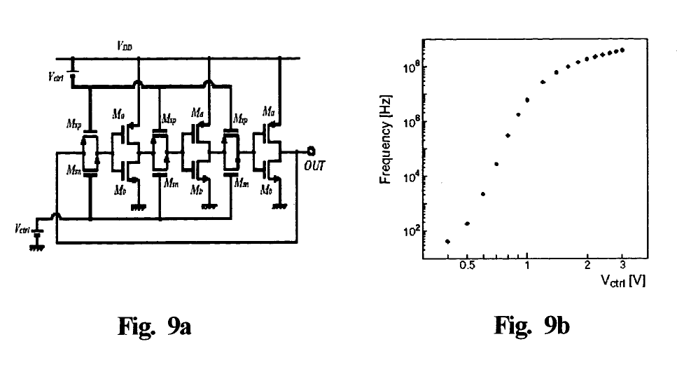

The possible structure of the block 300 is shown in FIG. 8. According to this drawing the column voltage pulse from the column waveform generator 200 is electrically connected to a resistive voltage divider 300a. As all of the resistors connected between the divider 300a output ports are equal the output voltages are proportional to the output port number. Each output port connected to one of a plurality of identical VCOs 300b creating the required by the steering strategy frequency chirp-up, chirp-down, or constant signals. According to FIG. 8 each VCO has two outputs with 90 degrees phase inverter 300c in one of the output that creates tow identical output signals: cos(m*.delta.omera.(.t.)) and sin(m*.delta.omera.(.t.)) where m is the output port number. Up to 100 MHz the whole block 300 can be designed as single inexpensive (several hundred dollars) solid-state silicon-based chip. For example, the three stages silicon based voltage controlled ring oscillator circuit and its frequency-voltage characteristic disclosed in the paper [23] and incorporated herein by reference is shown FIGS. 9a and 9b.

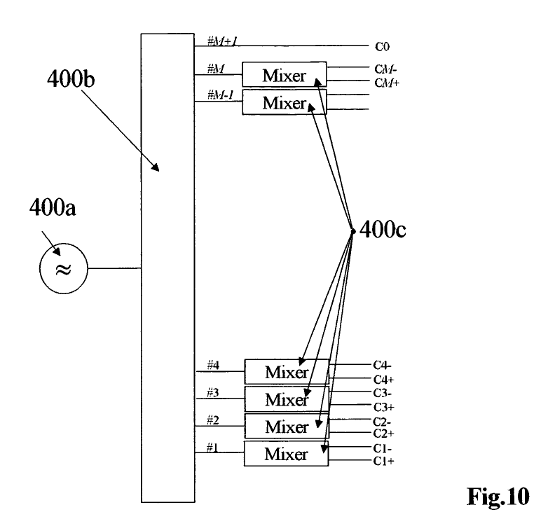

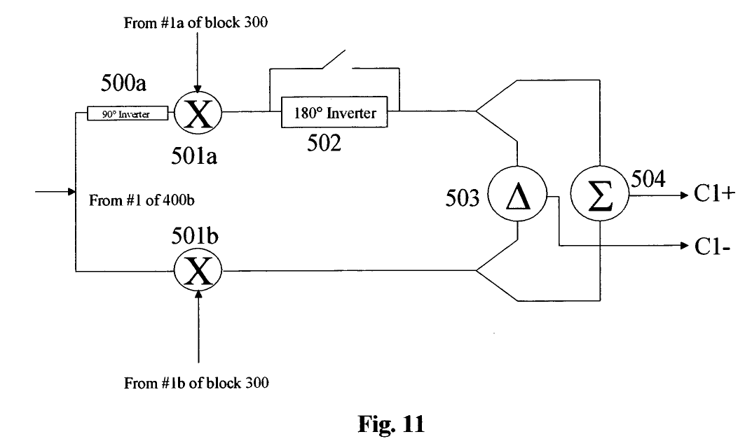

The possible structure of the block 400 is shown in FIG. 10. According to this drawing the STALO or any other source of signal 400a trough the 1: (M+1) power divider 400b is electrically connected to a plenty of identical mixtures 400c. Each mixer 400c has two outputs with signals: .Cm+.=cos((.omega0.+m*.delta.omega. (.t.))*.t.) and .Cm−.=cos((.omega0.−m*.delta.omega.(.t.))*.t.) required to feed the radiating elements and steer beams. The simplified mixer circuit connected to port #1 is shown in FIG. 11. That is some modification of balance mixer with new features: 180 degrees inverter 502 with switch “on” and “off” and two outputs 503 and 504, one for the sum-signal .C1+. and the second for the difference-signal C1−. If the switch is “on” the antenna beam peak is scanned in the direction of positive angle phi. or .theta. The switch position “off” reverses the direction of scan to negative angles.

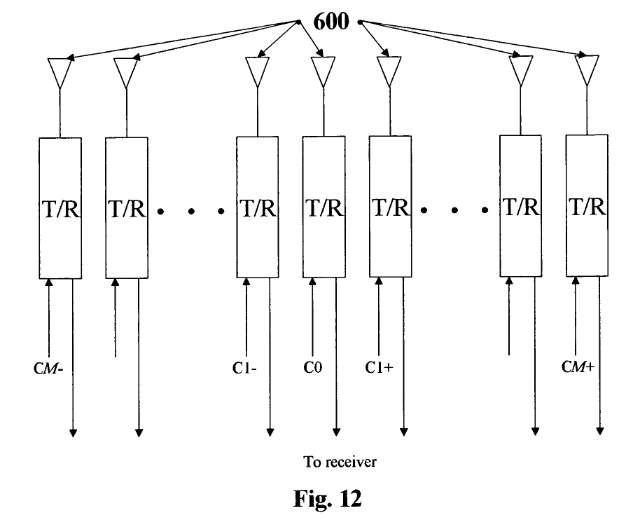

Finally all the transmitted signals from the block 400 go to HPA inside each of T/R modules electrically connected to a plenty of the radiating elements 600 as shown in FIG. 12. In order to get the shifted phase center of AESA required for the present invention the signal with the lowest frequency swing must come to the bottom left or right element.

The signals returning from a target or targets go trough a plenty of LNAs (Low Noise Amplifiers) electrically connected to each of radiating element. A plenty of signals coming from LNAs goes to a plenty of receiver mixers. Each mixer mixes the target return signal with one of the output signals coming from the system shown in FIG. 7, then all mixer output baseband signals are summarized and as a combine received from target signal goes to the processing block shown in FIG. 6.

Note that most part of required video signals inside the system shown in FIG. 6 and FIG. 7 can be digitally performed.

While specific embodiments of the present invention have been illustrated and described in its preferred embodiments, it will be understood by those having ordinary skill in the art that changes may be made to those embodiments without departing from the spirit and scope of the invention in its broader aspects.

1. An ultra-high resolution radar with flat (or conformal) transmit/receive AESA or AESAs steering beam or beams non-dispersively, comprising:
waveform signal generators which generate a train of designated forms of voltage pulse signals with designated repetition times, said voltage pulse signal duration is at least longer than the required duration of the AESA transmitting or receiving pulse signals;
a means for creating a plurality of RF FM modulated pulse signals of identical shape and duration but different consecutive magnitude comprising a resistive multiport voltage dividers electrically connected to said waveform generators, said resistive multiport voltage dividers providing plurality of said voltage pulse signals, a plurality of VCOs electrically connected to said resistive multiport voltage dividers, a plurality of mixers electrically connected to VCOs, STALO, and to a plurality of radiating elements in order to generate signals providing simultaneously the required beam or beams azimuth and elevation steering electronically and transmitting pulse signals to illuminate radar targets;
a means for generating said transmitting pulse signals which phase and power spectrum depends on azimuth and elevation angles comprising resistive multiport voltage dividers electrically connected to said waveform generators, said resistive multiport voltage dividers providing plurality of said voltage pulse signals, a plurality of VCOs electrically connected to said resistive multiport voltage dividers, a plurality of mixers electrically connected to VCOs, STALO, and to a plurality of radiating elements in order to generate signals providing simultaneously the required beam or beams azimuth and elevation steering electronically and transmitting pulse signals to illuminate radar targets;
a transmit/receive flat (or conformal) AESA comprising plurality of said radiating elements uniform or nonuniform spaced, said radiating elements uniform or nonuniform excited to transmit and collect propagating electromagnetic energy which are excited or collect energy in such a way that the bottom left or bottom right radiation element of AESA radiates or receives a nonmodulated carrier signal.

2. An ultra-high resolution radar with transmit/receive AESA or AESAs steering beam or beams non-dispersively, comprising:
waveform signal generators which generates a train of designated forms of voltage pulse signals with designated repetition times, said voltage pulse signal duration is at least longer than the required duration of the AESA receiving pulse signals;
a means for creating a plurality of RF FM modulated pulse signals of identical shape and duration but different consecutive magnitude comprising resistive multiport voltage dividers electrically connected to said waveform generators, said resistive multiport voltage dividers providing plurality of said voltage pulse signals, a plurality of VCOs electrically connected to said resistive multiport voltage dividers, a plurality of mixers electrically connected to VCOs, STALO, and to a plurality of radiating elements in order to generate signals providing simultaneously the required beam or beams azimuth and elevation steering electronically and receiving target-echo return pulse signals;
a means for creating and combining the receiving signals which is electrically connected to plurality of LNAs (Low Noise Amplifiers) amplifying said target-echo return signals those are received by a plurality of said radiating elements comprising a plurality of mixers electrically connected to said LNA outputs, said power combiners, and a plurality of said mixers creating said FM signals for transmitting part of said radar;

3. An ultra-high resolution radar with transmit/receive AESA or AESAs steering beam or beams non-dispersively, comprising:
waveform signal generators which generates a train of designated forms of voltage pulse signals with designated repetition times, said voltage pulse signal duration is at least longer than the required duration of the AESA receiving pulse signals;
a means for creating a plurality of RF FM modulated pulse signals of identical shape and duration but different consecutive magnitude comprising resistive multiport voltage dividers electrically connected to said waveform s, said resistive multiport voltage dividers providing plurality of said voltage pulse signals, a plurality of VCOs electrically connected to said resistive multiport voltage dividers, a plurality of mixers electrically connected to VCOs, STALO, and to a plurality of radiating elements in order to generate signals providing simultaneously the required beam or beams azimuth and elevation steering electronically and receiving target-echo return signals;
a means for producing the receiving signals which is electrically connected to a plurality of LNAs amplifying the signals those are reflected from illuminated targets and received by a plurality of said radiating elements comprising a plurality of mixers electrically connected to said LNA outputs, said power combiners, and a plurality of said mixers creating said FM signals for transmitting part of said radar;
a means for processing target-echo return signals which is electrically connected to said receiving AESA or AESAs, said processing means being electrically connected with narrow band filters in order to enhance signal-to-noise ratio for detecting said target-echo return signals with said phase and power spectrum depending on angular target positions and range of a targets, and in order to get ultra-high angular and range resolution.
